(19) United States
(12) Patent Application Publication
(10) Pub. No.: US 2015/0103431 A1
(43) Pub. Date: Apr. 16, 2015

(54) STO WITH ANTI-FERROMAGNETIC COUPLING INTERLAYER

(71) Applicant: HGST Netherlands B.V., Amsterdam (NL)

(72) Inventors: Masukaza IGARASHI, Kawagoe (JP); Keiichi NAGASAKA, Isehara (JP); Masato SHIIMOTO, Odawara (JP)

(73) Assignee: HGST NETHERLANDS B.V., Amsterdam (NL)

(21) Appl. No.: 14/052,370

(22) Filed: Oct. 11, 2013

(51) Int. Cl. G11B 33/14; G11B 5/31

(52) U.S. Cl. CPC G11B 33/1406; G11B 5/3116; G11B 2005/0024
USPC 360/59

(57) ABSTRACT

Embodiments described herein generally relate to a magnetic recording device for recording/reproducing data using the magnetization state of a recording medium. More specifically, embodiments described herein provide an STO structure having an SPL and an FGL with an anti-ferromagnetic coupling interlayer disposed between the SPL and FGL. The anti-ferromagnetic coupling interlayer may enable the STO structure to obtain a high assist effect even when operated with a low conducting current.

### BACKGROUND OF THE INVENTION

1. Field of the Invention

Embodiments described herein generally relate to a magnetic recording device for recording/reproducing data using the magnetization state of a recording medium. More specifically, embodiments described herein relate to a spin-torque oscillator (STO) with an anti-ferromagnetic coupling interlayer.

2. Description of the Related Art

The heart of a computer is a magnetic disk drive which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing, the write and read heads are employed for writing magnetic impressions to and reading magnetic signal fields from the rotating disk. The read and write heads are connected to processing circuitry that operates according to a computer program to implement the writing and reading functions.

In recent years, the data recording density of magnetic recording devices has continued to increase and the size of 1 bit of a magnetic recording mark for recording to a magnetic medium continues to become smaller. When the magnetic recording density exceeds about 1 Tera bit per square inch (Tbpsi), there is a risk of data recorded to a magnetic recording medium being erased at room temperature due to the effects of heat fluctuation. In order to prevent data from being erased by the effect of heat fluctuation, it is generally necessary to raise the coercive force of the magnetic recording medium. However, there is a limit to the amount of magnetic flux released by a magnetic recording head from recording data by magnetization reversal of a magnetic recording medium.

Measures for solving the above referenced problem have recently focused on assisted recording systems for recording data in conjunction with other technology. One such measure that has been proposed to achieve a high recording density is a method in which a microwave assisted magnetic recording (MAMR) head is utilized. A high frequency magnetic field is applied to recording bits in a magnetic recording medium in order to weaken the coercive force of the recording bits. In this method, data may be recorded using a conventional magnetic recording head. A MAMR enabled magnetic recording head utilizes an STO for generating a microwave (high frequency AC magnetic field). Typically the STO may include a field generation layer (FGL) for generating an AC magnetic field, a spacer layer, and a spin polarization layer (SPL) for transmitting spin polarized torque.

High quality recording can be achieved because the coercive force of the recording medium is lowered when the AC magnetic field is applied to the recording medium. This phenomenon is known as the “assist effect.” Thus, it is important to develop an STO that generates an adequately large AC magnetic field in the MAMR. However, as the value of the applied current to the STO increases, reliability is reduced by a temperature increase of the STO.

Therefore, there is a need in the art for an STO structure where both the FGL and the SPL oscillate and obtain a high assist effect for a low conducting current.

### SUMMARY OF THE INVENTION

Embodiments described herein generally relate to a magnetic recording device for recording/reproducing data using the magnetization state of a recording medium. More specifically, embodiments described herein provide an STO structure having an SPL and an FGL with an anti-ferromagnetic coupling interlayer disposed between the SPL and FGL. The anti-ferromagnetic coupling interlayer may enable the STO structure to obtain a high assist effect even when operated with a low conducting current.

In one embodiment, an MAMR head is provided. The MAMR head may comprise a main magnetic pole, a trailing shield, and an STO disposed between the main magnetic pole and the trailing shield. The STO may comprise a first magnetic layer, and anti-ferromagnetic coupling interlayer, and a second magnetic layer. The first magnetic layer, the anti-ferromagnetic coupling interlayer, and the second magnetic layer may be laminated in order from the main pole. An anti-ferromagnetic coupling energy of the first magnetic layer and the second magnetic layer may be between about −0.2 erg/cm² and about −4.0 erg/cm².

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an exemplary magnetic disk drive, according to certain embodiments.

FIG. 2 is a cross-sectional side view of a read/write head and magnetic disk of the disk drive of FIG. 1, according to certain embodiments.

FIG. 3A depicts a conventional MAMR head operating in the T-mode.

FIG. 3B depicts a conventional MAMR head operating in the AF-mode.

FIG. 3C1-3C6 depict the time dependence of the magnetization in the film plane of the FGL and the SPL when varying amounts of input current are applied in a conventional AF-mode STO.

FIGS. 4A and 4B are cross-sectional, schematic views of a portion of an MAMR head, according to certain embodiments.

FIG. 5 depicts recording characteristics of the MAMR heads of FIGS. 4A and 4B.

FIG. 6A-6F depict graphs showing the time dependence of an in-plane generated component of the magnetization of the FGL and the SPL of MAMR heads of FIGS. 4A and 4B.

FIG. 7 is a graph depicting the exchange coupling energy dependence of the signal to noise ratio (SNR).

FIG. 8 is a graph depicting the exchange coupling energy dependence of the AC magnetic field strength.

FIG. 9 is a graph depicting the relationship between the exchange coupling energy and the film thickness of various materials utilized for an anti-ferromagnetic coupling interlayer.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

The STO structure, according to various embodiments described herein, may be disposed between a main magnetic pole of a recording head and a trailing shield. The STO may comprise a first perpendicular magnetic layer (SPL) having an axis of magnetic anisotropy in the direction perpendicular to a film plane, an anti-ferromagnetic coupling conduction layer, and a magnetic layer (FGL) effectively having a plan of easy magnetization in the film plane. The STO may exhibit AF-mode oscillations and conduct current from the FGL to the SPL. The SPL film thickness may be thinner than that of the FOL. Anti-ferromagnetic coupling between the FGL and the SPL may be achieved by the anti-ferromagnetic coupling interlayer.

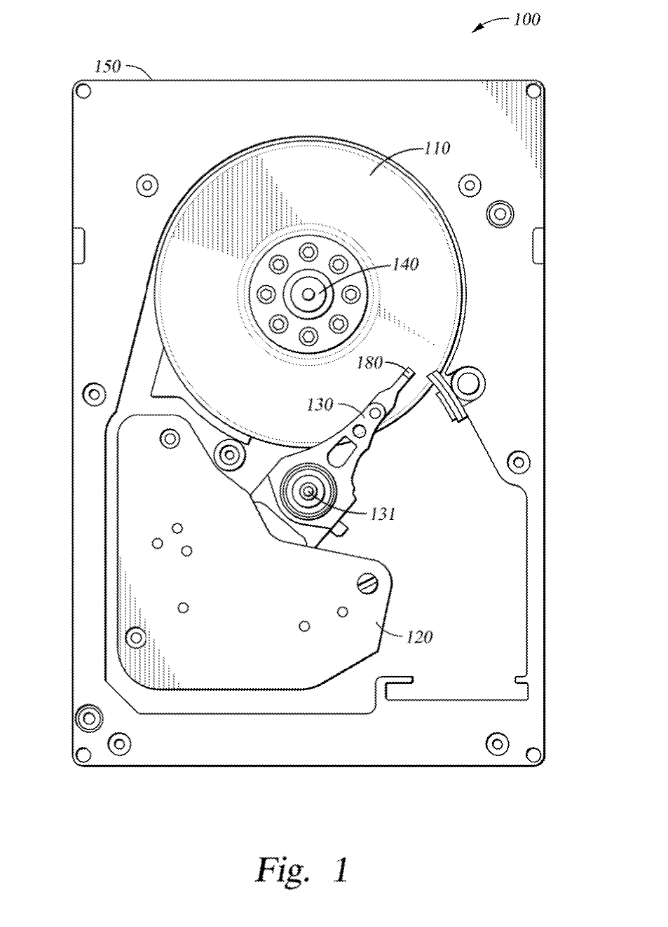

FIG. 1 illustrates a top view of an exemplary hard disk drive (HDD) 100. The HDD 100 may include one or more magnetic disks 110, an actuator 120, actuator arms 130 associated with each of the magnetic disks 110, and a spindle motor 140 affixed in a chassis 150. The one or more magnetic disks 110 may be arranged vertically as illustrated in FIG. 1. Moreover, the one or more magnetic disks may be coupled with the spindle motor 140.

The magnetic disks 110 may include circular tracks of data on both the top and bottom surfaces of the disk. A magnetic head 180 mounted on a slider may be positioned adjacent a track. As each disk spins, data may be written on and/or read from the data track. The magnetic head 180 may be coupled to the actuator arm 130. The actuator arm 130 may be configured to swivel around an actuator axis 131 to place the magnetic head 180 adjacent a particular data track.

The above description of a typical magnetic disk storage system and the accompanying illustration of FIG. 1 are for representation purposes only. It should be apparent that disk storage systems may contain a large number of disks and actuators, and each actuator may support a number of sliders.

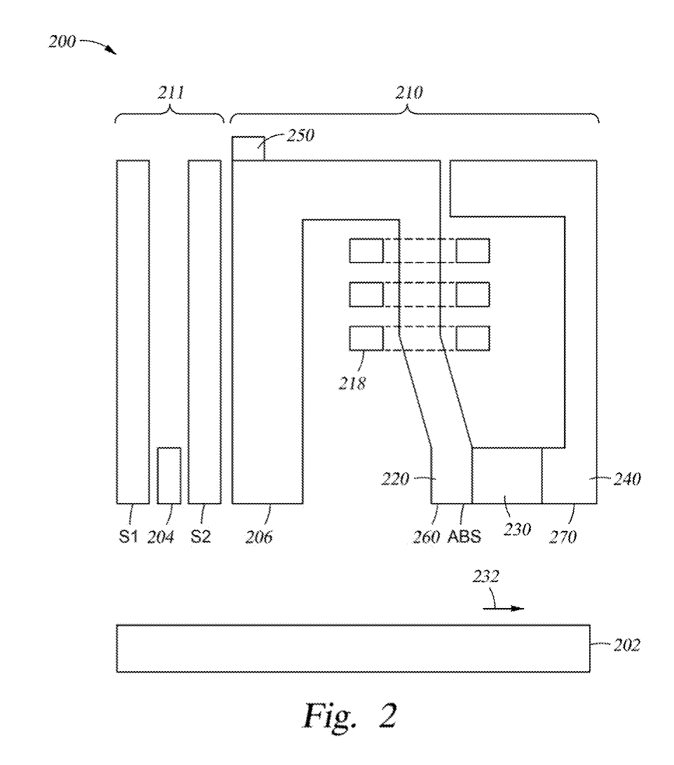

FIG. 2 is a fragmented, cross sectional side view through the center of a MAMR read/write head 200 facing a magnetic disk 202. The read/write head 200 and the magnetic disk 202 may correspond to the magnetic head assembly 180 and the magnetic disk 110, respectively in FIG. 1. The read/write head 200 may include an ABS, a magnetic write head 210 and a magnetic read head 211, and may be mounted such that the ABS faces the magnetic disk 202. In FIG. 2, the disk 202 moves past the write head 210 in the direction indicated by the arrow 232.

The magnetic read head 211 may be a magnetoresistive (MR) read head that includes an MR sensing element 204 located between MR shields S1 and S2. In other embodiments, the magnetic read head 211 may be a magnetic tunnel junction (MTJ) read head that includes an MTJ sensing device 204 located between MR shields S1 and S2. The magnetic fields of the adjacent magnetized regions in the magnetic disk 202 are detectable by the MR (or MTJ) sensing element 204 as the recorded bits.

The write head 210 may include a return pole 206, an STO 230 disposed between a main pole 220 and a trailing shield 240, and a coil 218 that excites the main pole 220. A recording magnetic field generated from the main pole 220 and the trailing shield 240 helps making the magnetic field gradient of the main pole 220 steep. The main pole 220 may be a magnetic material such as a CoFe alloy. In one embodiment, the main pole 220 may have a saturated magnetization (Ms) of 2.4 T, a torque width of about 60 nm, and a thickness of about 300 nanometers (nm). The trailing shield 240 may be a magnetic material such as a NiFe alloy. In one embodiment, the trailing shield 240 has an Ms of about 1.2 T.

The main pole 220 and the trailing shield 240 have ends 260, 270 defining part of the ABS, and the STO 230 may be disposed between the main pole 220 and the trailing shield 240. The STO 230 may be surrounded by an insulating material in a cross-track direction (into and out of the paper). During operation, the STO 230 generates an AC magnetic field that travels to the magnetic disk 202 to lower the coercivity of the region of the magnetic disk 202 adjacent to the STO 230. The STO 230 will be discussed in detail below. The write head 210 may also include a heater 250 for adjusting the distance between the read/write head 200 and the magnetic disk 202. The location of the heater 250 is not limited to above the return pole 206, as shown in FIG. 2. The heater 250 may be disposed at any suitable location.

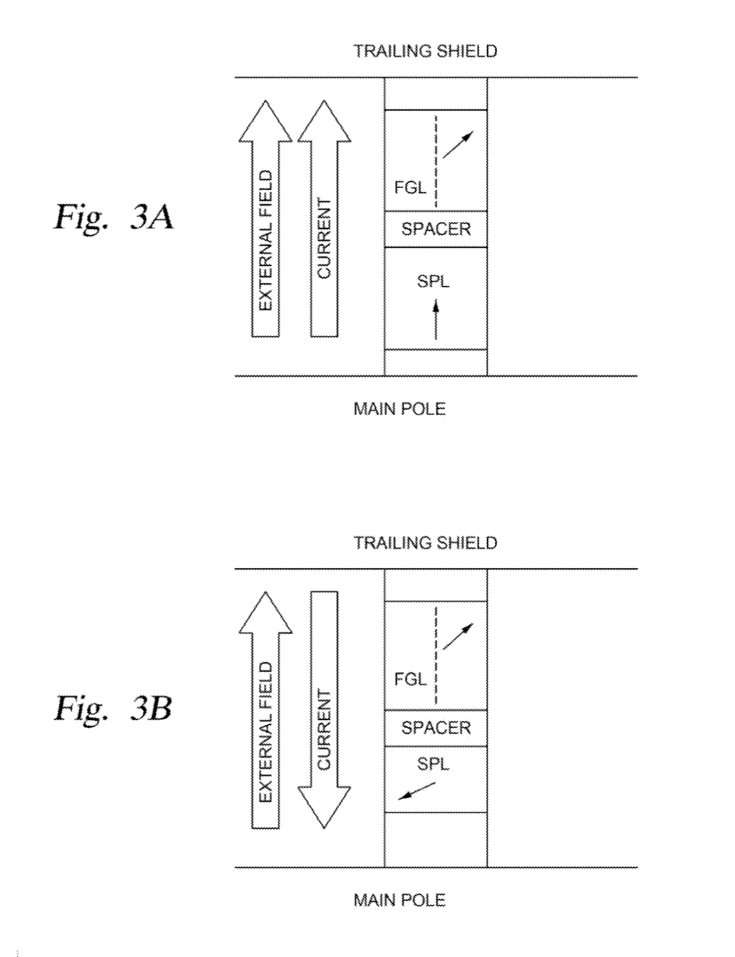

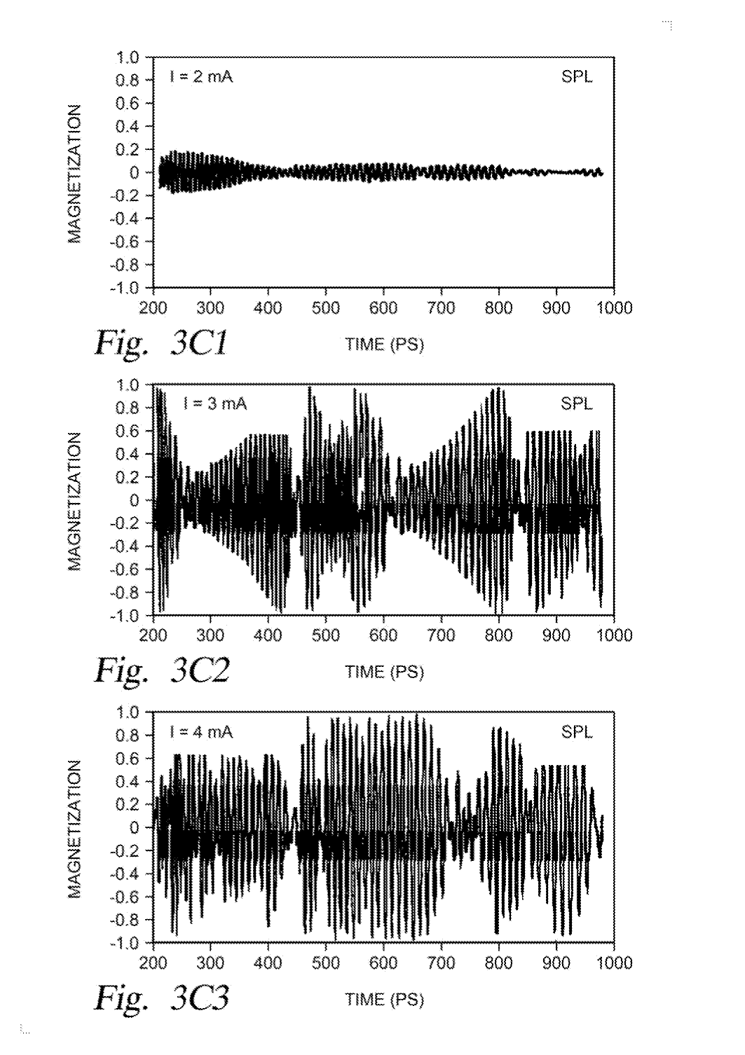

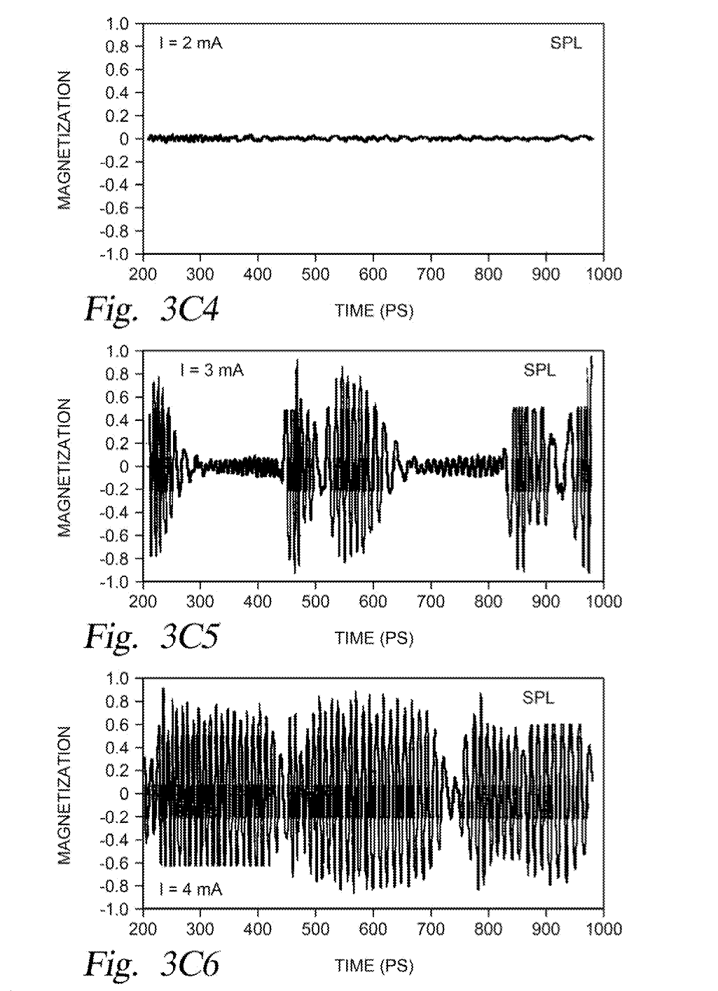

FIG. 3A depicts a conventional MAMR head operating in the T-mode. Current may be conducted in the direction from the SPL to the FGL in the STO. The spin torque acts in the same direction as the magnetization of the FGL in the magnetization of the SPL. The spin torque acts in the anti-parallel direction to the magnetization of the SPL in the magnetization of the FGL. As a perpendicular magnetic field is added to the STO, the magnetization of the SPL becomes stable in the perpendicular direction. On the other hand, the FGL magnetization oscillates when the in-plane component is large. The oscillation of the STO having this structure is referred to as T-mode because the SPL and the FGL oscillate in the shape of the letter T.

FIG. 3B depicts a conventional MAMR head operating in the AF-mode. In this structure, the SPL magnetization is effectively directed in the film plane and both the FGL and the SPL oscillate. Specifically, the structure used has a thinner film thickness of the SPL and a low perpendicular anisotropic magnetic field so that current is conducted from the FGL in the direction of the SPL and the effective anisotropic magnetic field of the SPL becomes zero. In this structure, in order to not create reversal delays in the SPL magnetization caused by switching the current polarity of the write head magnetic field, a characteristic is fast FGL reversals that are advantageous in high speed transmission recordings. The STO oscillations of this structure are referred to as AF-mode oscillations because the SPL and the FGL are held in the anti-parallel state.

FIG. 3C1-3C6 depict the time dependence of the magnetization in the film plane of the FGL and the SPL when varying amounts of input current are applied in a conventional AF-mode STO. For example, when a small current, such as 2 mA is applied, the FGL may not oscillate because the applied spin torque is too small. Thus, the resulting AC magnetic field that was generated decreases and an assist effect is not obtained. If a larger current, such as 3 mA, is applied, the time averaged AC magnetic field generated by the FGL attenuates and a large assist effect may not be obtained. The unstable FGL oscillations at low current are a result of the magnitude of the spin torque applied to the FGL. The SPL is proportional to the conducted current value and inversely proportional to the film thickness and the saturated magnetization. The saturated magnetization and the film thickness of the SPL must be smaller than those of the FGL, therefore, the magnitude of the spin torque applied to the SPL is larger than the spin torque applied to the FGL. As result, when the relative bias current is relatively low, the SPL oscillates relatively stably but the FGL repeatedly oscillates and stops because the torque applied to the FGL is small.

If an even larger current is applied, such as 4 mA, the FGL and the SPL maintain a large in plane magnetization component and oscillate stably over time and a large assist effect is effectively obtained under these conditions. As previously described, a large application current may be necessary to obtain a large assist effect because the FGL does not oscillate stably when a small current is applied to the STO.

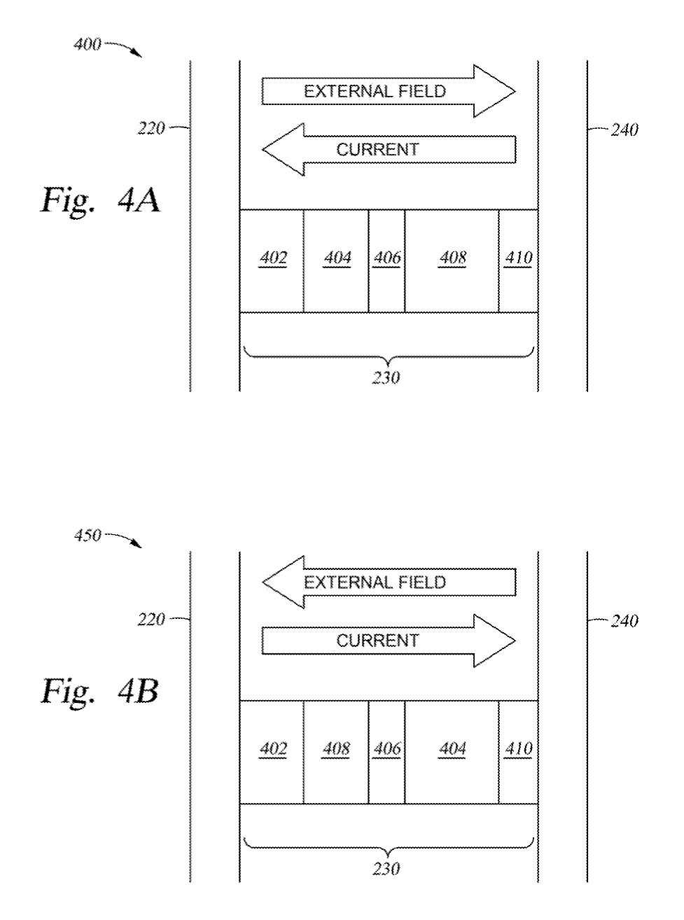

FIG. 4A is a schematic, cross-sectional view of a portion of an MAMR head 400 according to one embodiment described herein. The MAMR head 400 may be utilized as the magnetic write head 210 discussed with regard to FIG. 2 and may include the STO 230. The STO 230 may be disposed between the main pole 220 and the trailing shield 240. Other features of the MAMR head 400 are not shown for the sake of clarity. The STO 230 may comprise an underlayer 402, and SPL 404, a non-magnetic layer 406, an FGL 408, and a cap layer 410. The various components 402, 404, 406, 408, 410 of the STO 230 may be formed in the order described above from the main pole 220 to the trailing shield 240. The STO 230 may have a track width of between about 30 nm and about 50 nm, such as about 40 nm. Similarly, the STO 230 may have an element height of between about 30 nm and about 50 nm, such as about 40 nm. The underlayer 402 and may comprise a conductive material, such as Ta, and may have a thickness of between about 1 nm and about 3 nm, such as about 2 nm. The cap layer 410 may also comprise a conductive material, such as Cr, and may have a thickness of between about 1 nm and about 3 nm, such as about 2 nm.

The FGL 408 may comprise a magnetic material or magnetic alloy, such as CoFe, and the FGL 408 may have a thickness of between about 5 nm and about 15 nm, such as about 10 nm. The perpendicular anisotropic magnetic field (Hk) of the FGL 408 may be from about −1 to about 1, such as about 0. The saturated magnetization (Ms) may be from about 1 T to about 3 T, such as about 2.3 T. In certain embodiments, it may be desirable to increase the in-plane component of the FGL 408 magnetization. As such, a material having a larger Ms and a zero or negative perpendicular anisotropic energy may be employed for the FGL 408.

The SPL 404 may also comprise a magnetic material or magnetic alloy, such as Co, Ni, or CoNi, and the SPL 404 may have a thickness of between about 2.5 nm and about 4.5 nm, such as about 3.5 nm. The perpendicular anisotropic magnetic field of the SPL 404 may be from about 10 kOe to about 16 kOe, such as about 143 kOe. The non-magnetic layer 406, or anti-ferromagnetic coupling interlayer, may be disposed between the SPL 404 and the FGL 408. As a result, the SPL 404 and the FGL 408 may be anti-ferromagnetically coupled.

The non-magnetic layer 406 may comprise a non-magnetic material, such as Cu, Cr, Ru, Rh or Ir. A thickness of the non-magnetic layer 406 may be between about 0.4 nm and about 1.5 nm, such as about 0.8 nm. The exchange coupling energy of the FGL 408 and the SPL 404, the perpendicular anisotropic film and the magnetic layer, respectively, may exhibit a plane of easy magnetization in the film plane from about −0.2 erg/cm² to about −4.0 erg/cm², such as about −1.6 erg/cm². In a conventional AF-mode STO, the interlayer may be Cu, have a film thickness of about 3 nm, and exhibit an exchange coupling energy of about 0 erg/cm². Thus, the MAMR head 400 with the STO 230 having the anti-ferromagnetic coupling interlayer 406 may provide for an improved signal to noise ratio (SNR) when compared to a conventional AF-mode STO.

In AF-mode operation, the current may flow from the FGL 408 in the direction of the SPL 404. As such, the current may flow from the trailing shield 240 to the main pole 220. In the STO 230 structure described above, the SPL 404 may easily increase the reversal speed of the SPL 404 because the SPL 404 is positioned on the main pole 220 side that has a strong magnetic field of a trailing gap. Further, the stability of the oscillations of the FGL 408 and the SPL 404 may be improved.

FIG. 4B is a schematic, cross-sectional view of a portion of an MAMR head 450 according to another embodiment described herein. The STO 230 of FIG. 4B differs from the STO 230 of FIG. 4A in the laminating order of the STO 230 components 402, 404, 406, 408, 410. Specifically, the STO 230 of FIG. 3A comprises the SPL 404, anti-ferromagnetic coupling interlayer 406, and the FGL 408 which may be laminated in order from the main pole 220. However, in FIG. 3B, the STO 230 comprises the FGL 408, the anti-ferromagnetic coupling interlayer 406, and the SPL 404 which may be laminated in order from the main pole 220. As a result of the change in lamination order, the current may flow from the main pole 220 to the trailing shield 240. In this example, an increase in the maximum value of the effective recording magnetic field strength that exhibits the assist effect of the AC magnetic field may be realized as a result of the FGL 408 being disposed close to the main pole 220.

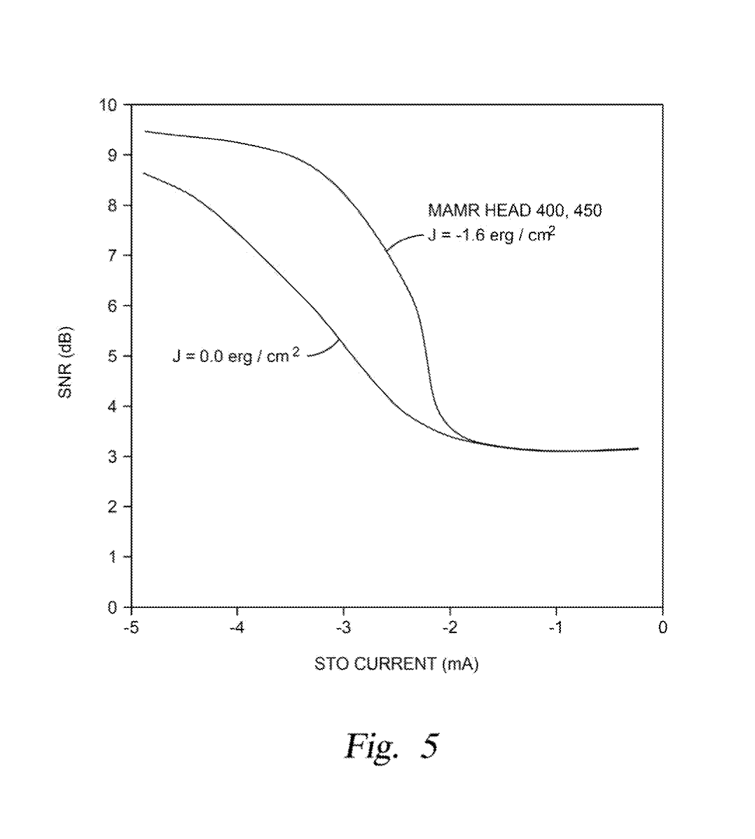

The STO structure of FIGS. 4A and 4B may obtain an advanced assistance effect and improved range of the exchange coupling energy of the SPL and the FGL. Moreover, an improved SNR may be obtained when compared to a conventional STO if the AF-mode. FIG. 5 depicts recording characteristics of the MAMR heads 400, 450 of FIGS. 4A and 4B, respectively. As depicted, the MAMR heads 400, 450 display an exchange coupling energy of −1.6 erg/cm² as compared to a conventional AF-mode STO which displays an exchange coupling energy of 0.0 erg/cm². Thus, the MAMR heads 400, 450 may provide a large increase in the SNR which results from the increase in the STO bias current when compared to a conventional AF-mode STO where the exchange coupling of the FGL and SPL is zero. In the MAMR heads 400, 450, the FGL may oscillate stably because the bias current value is relatively low.

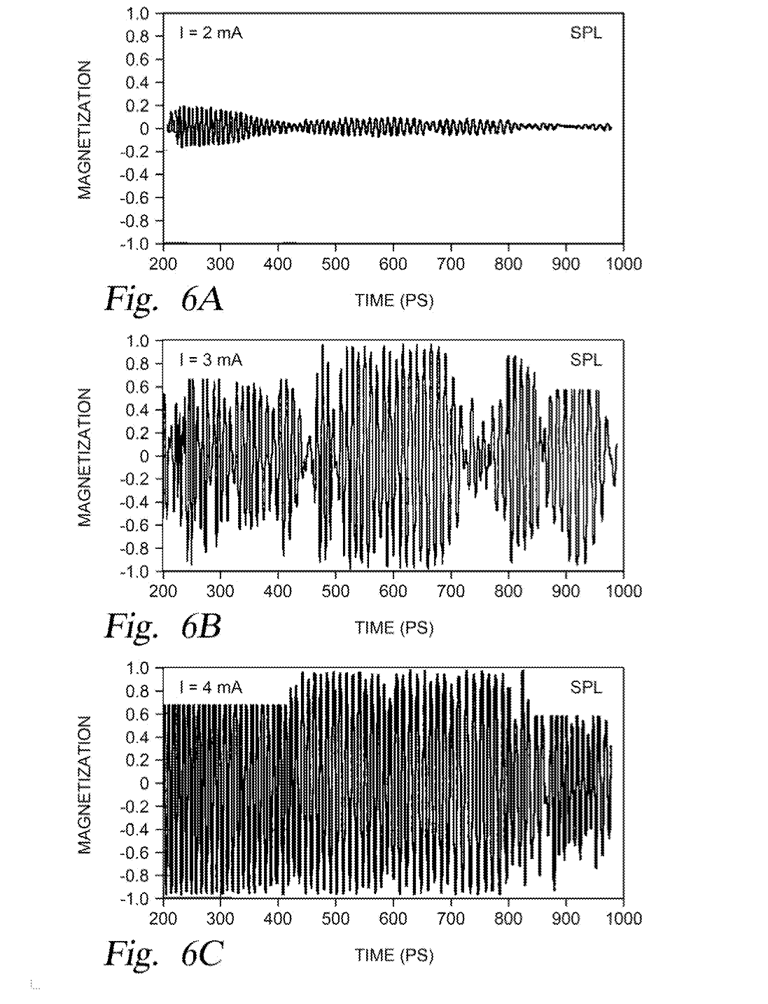

FIGS. 6A-6F depict graphs showing the time dependence of the in-plane generated component of the magnetization of the FGL and the SPL of MAMR heads 400, 450. For example, when the bias current value is about 2 mA, the FGL and the SPL do not oscillate similar to the conventional AF-mode STO as shown in FIG. 3C. The resulting difference in magnetization is the magnitude of the spin torque supplied to the SPL, which may be too small for the conventional AF-mode STO. When the bias current value is about 3 mA, in contrast to the conventional AF-mode STO, the FGL and the SPL oscillate relatively stably. Thus, advanced recording performance may be achieved by a high assist effect.

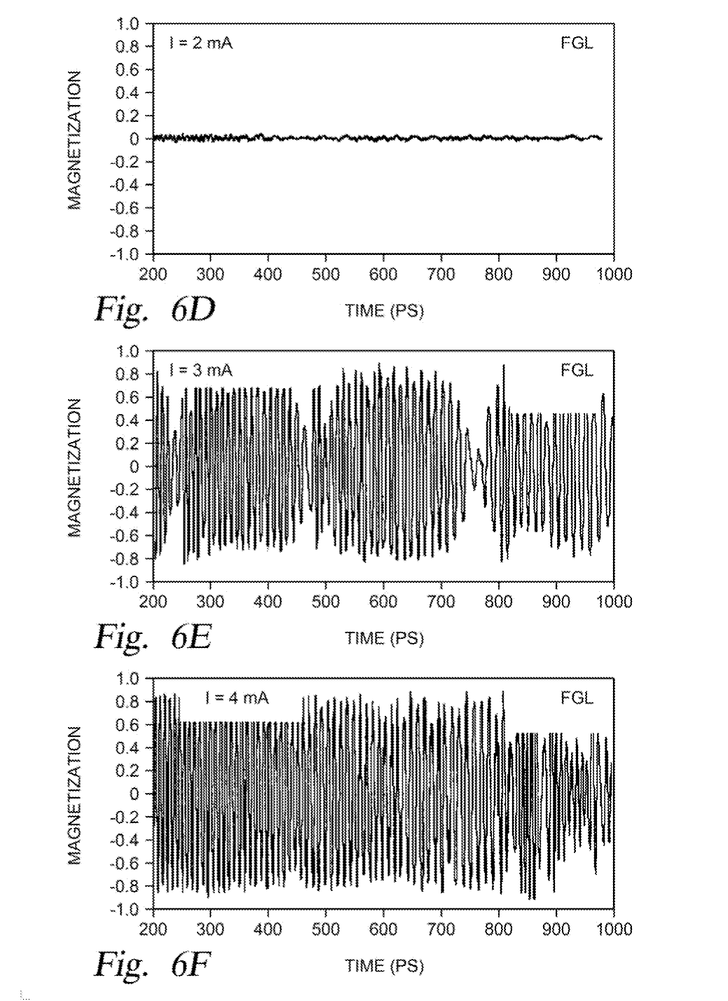

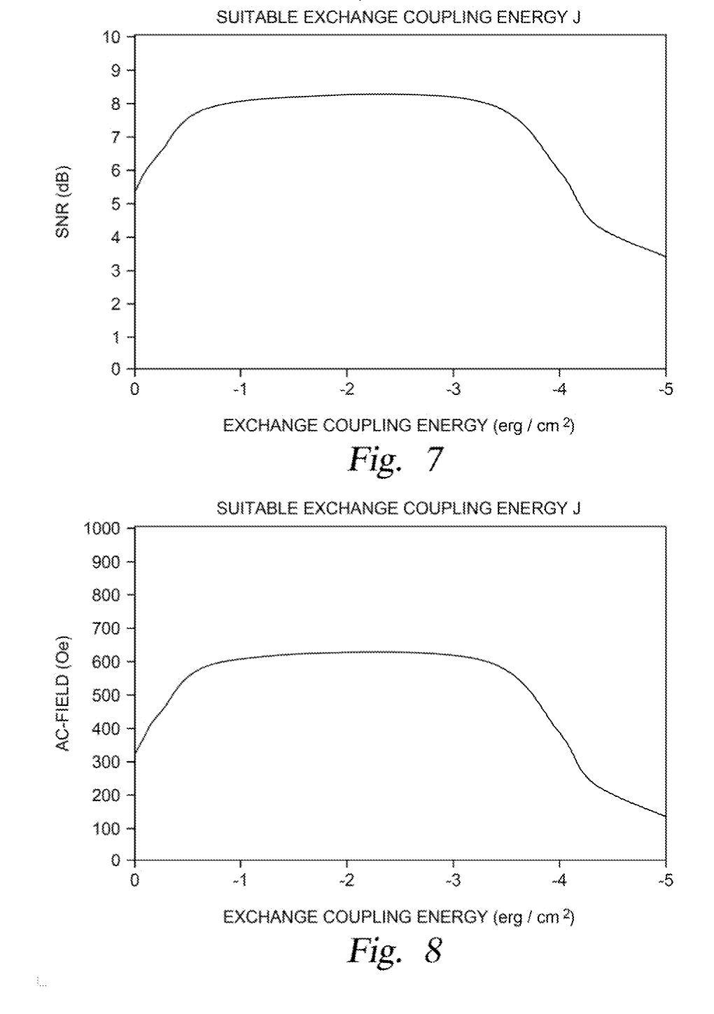

The range of the exchange coupling energy of the SPL and FGL that may obtain an advanced assist effect utilizing the anti-ferromagnetic coupling interlayer 406 are explained below. FIG. 7 and FIG. 8 are graphs depicting the exchange coupling energy dependence of the SNR and the AC magnetic field strength, respectively. The AC magnetic field strength is the value in the center of the recording layer of the magnetic recording medium. The head-medium distance in this example may be about 8 nm and the film thickness of the recording layer of the magnetic recording medium may be about 16 nm. In this example, a bias current to the STO of about 3 mA may be utilized. As depicted in FIG. 7, when the exchange coupling energy of the FGL and the SPL is set in the range from about −0.2 erg/cm² to about −4.0 erg/cm² and the exchange coupling energy corresponding to the conventional AF-mode STO structure is zero, and SNR gain of at least about 1 dB may be obtained. In addition, when the exchange coupling energy of the FGL and the SPL is set in the range from about −1.0 erg/cm² to about −3.0 erg/cm² and the exchange coupling energy corresponding to the conventional AF mode STO structure is zero, an SNR gain of at least about 3 dB may be obtained.

Because the exchange coupling energy dependence of the SNR corresponds well to the exchange coupling energy dependence of the AC magnetic field strength shown in FIG. 8, the SNR gain caused by controlling the exchange coupling energy may depend on the increase in the AC magnetic field of the FGL. The cause of the substantial attenuation of the AC magnetic field when the exchange coupling energy is too high is that the SPL magnetization is pinned and is different when the exchange coupling energy applied to the SPL is relatively high.

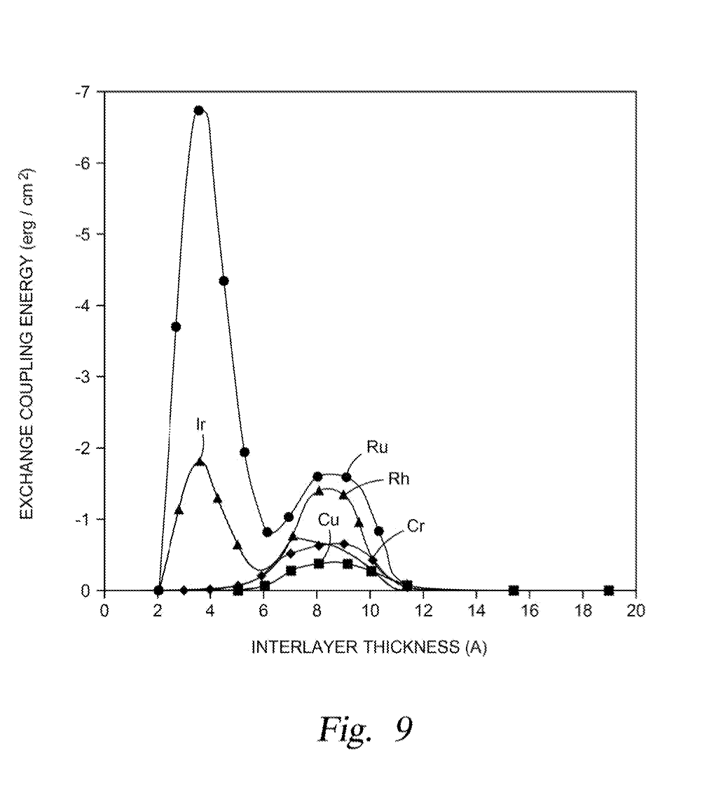

The range of the exchange coupling energy obtained by the high AC magnetic field and the SNR as described above may be realized by utilizing an appropriate material and film thickness in the anti-ferromagnetic coupling interlayer 406. Materials such as Ru, Cr, Cu, Rh, and Ir may be utilized as the anti-ferromagnetic coupling interlayer 406 and may be implemented with a film thickness of between about 0.4 nm to about 1.5 nm. FIG. 9 is a graph depicting the relationship between the exchange coupling energy and the film thickness of various materials utilized for the anti-ferromagnetic coupling interlayer 406. While the optimal range for each material may differ, an exchange coupling energy of between about −0.2 erg/cm² to about −4.0 erg/cm² may be obtained with a film thickness from about 0.4 nm to about 1.5 nm. For example, when the anti-ferromagnetic coupling interlayer material 406 is Ru, the thickness may be between about 0.4 nm and about 1.1 nm; when the anti-ferromagnetic coupling interlayer material 406 is Cr or Cu, the thickness may be between about 0.6 nm and about 1.1 nm; when the anti-ferromagnetic coupling interlayer material 406 is Rh, the film thickness may be between about 0.6 nm and about 1.0 nm; and when the anti-ferromagnetic coupling interlayer material 406 is Ir, the film thickness may be between about 0.2 nm and about 1.0 nm.

Table 1 depicts the relationship between the AC magnetic field and the SNR when the materials described with regard to FIG. 9 are utilized with an appropriate film thickness when compared to a conventional STO) structure. From Table 1, it can be seen that a high SNR may be achieved by providing the film thickness of an appropriate anti-ferromagnetic coupling interlayer material between about 0.4 nm and about 1.5 nm.

TABLE 1

| | Conventional | Invented | Invented | Invented | Invented | Invented | No-Gain |
|---|---|---|---|---|---|---|---|
| | Structure | Structure | Structure | Structure | Structure | Structure | Structure |
| Spacer | Cu | Ru | Cr | Cu | Ir | Rh | Ru |
| Material | | | | | | | |
| Spacer | 3.0 | 0.8 | 0.8 | 1.0 | 0.4 | 0.8 | 0.4 |
| Thickness | | | | | | | |
| (nm) | | | | | | | |
| Exchange | 0 | −1.6 | −0.7 | −0.3 | −1.9 | −1.6 | −6.8 |
| Energy | | | | | | | |
| (erg/cm²) | | | | | | | |
| AC Field | 320 | 620 | 570 | 450 | 610 | 620 | 200 |
| (Oe) | | | | | | | |
| SNR (dB) | 4.2 | 8.2 | 7.8 | 6.2 | 8.2 | 8.2 | 3.2 |
| @STO 1 = 3 mA | | | | | | | |

In sum, the STO, according to the embodiments described herein, may exhibit AF-mode oscillations and conduct current from the FGL to the SPL. The SPL film thickness may be thinner than that of the FGL. Anti-ferromagnetic coupling between the FGL and the SPL may be achieved by the anti-ferromagnetic coupling interlayer. Ultimately, the anti-ferromagnetic coupling interlayer may enable the FGL and the SPL to oscillate stably in the AF-mode and obtain a high assist effect for a low conducting current.

While the foregoing is directed to embodiments of the present invention, other and further embodiments of the invention may be devised without departing from the basic scope thereof, and the scope thereof is determined by the claims that follow.

1. A microwave assisted magnetic recording (MAMR) head, comprising:
a main magnetic pole;
a trailing shield;
a spin-torque oscillator (STO) disposed between the main magnetic pole and the trailing shield, the STO comprising:
a first magnetic layer;
an anti-ferromagnetic coupling interlayer; and
a second magnetic layer, wherein the first magnetic layer, the anti-ferromagnetic coupling interlayer, and the second magnetic layer are laminated in order from the main magnetic pole, and wherein an anti-ferromagnetic coupling energy of the first magnetic layer and the second magnetic layer is between about −0.2 erg/cm² and about −4.0 erg/cm².

2. The MAMR head of claim 1, wherein a film thickness of the first magnetic layer is thinner than a film thickness of the second magnetic layer.

3. The MAMR head of claim 2, wherein the film thickness of the first magnetic layer is between about 2.5 nm and about 4.5 nm.

4. The MAMR head of claim 3, wherein the first magnetic layer comprises Co and/or Ni.

5. The MAMR head of claim 3, wherein the film thickness of the second magnetic layer is between about 5 nm and about 15 nm.

6. The MAMR head of claim 5, wherein the second magnetic layer comprises CoFe.

7. The MAMR head of claim 2, wherein a conduction direction of the STO is from the trailing shield to the main magnetic pole.

8. The MAMR head of claim 2, wherein the first magnetic layer and the second magnetic layer are anti-ferromagnetically coupled through the anti-ferromagnetic coupling layer.

9. The MAMR head of claim 1, wherein a film thickness of the first magnetic layer is thicker than the second magnetic layer.

10. The MAMR head of claim 9, wherein the film thickness of the first magnetic layer is between about 5 nm and about 15 nm.

11. The MAMR head of claim 10, wherein the first magnetic layer comprises CoFe.

12. The MAMR head of claim 10, wherein the film thickness of the second magnetic layer is between about 2.5 nm and about 4.5 nm.

13. The MAMR head of claim 12, wherein the second magnetic layer comprises Co and/or Ni.

14. The MAMR head of claim 9, wherein a conduction direction of the STO is from the main magnetic pole to the trailing shield.

15. The MAMR head of claim 9, wherein the first magnetic layer and the second magnetic layer are anti-ferromagnetically coupled through the anti-ferromagnetic coupling layer.

16. The MAMR head of claim 1, wherein a film thickness of the anti-ferromagnetic coupling layer is between about 0.4 nm to about 1.5 nm.

17. The MAMR head of claim 1, wherein the anti-ferromagnetic coupling layer is selected from the group consisting of Ru, Cr, Cu, Rh, and Ir.

18. The MAMR head of claim 1, wherein the STO further comprises an underlayer and a cap layer.

19. The MAMR head of claim 2, wherein the first magnetic layer has a plane of easy magnetization in a first magnetic layer plane.

20. The MAMR head of claim 9, wherein the second magnetic layer has a plane of easy magnetization in a second magnetic layer plane.
